(19) United States
(12) Patent Application Publication
(10) Pub. No.: US 2023/0340234 A1
(43) Pub. Date: Oct. 26, 2023

(54) POLYMER COMPOSITE WITH LOW DIELECTRIC CONSTANT

(71) Applicant: DUPONT POLYMERS, INC., Wilmington, DE (US)

(72) Inventors: Jianying Chen, (US); Ting Wang, (US)

(21) Appl. No.: 17/758,921

(22) PCT Filed: Jan. 20, 2021
(86) PCT No.: PCT/US2021/014082

§ 371 Date: Jul. 15, 2022

(30) Foreign Application Priority Data
Jan. 20, 2020 (CN) 202010062516.4

(51) Int. Cl. C08K 9/02; C08K 3/36; C08K 9/10; C08K 3/22

(52) U.S. Cl. CPC C08K 9/02; C08K 3/36; C08K 9/10; C08K 3/22; C08K 2003/2217; C08K 2003/2237

(57) ABSTRACT

Disclosed herein are polymer compositions comprise at least one thermoplastic polymer and dispersed therein core/shell particles, wherein the core/shell particles comprise MgTiO₃ core and SiO₂ shell.

### FIELD OF DISCLOSURE

This invention relates to thermoplastic compositions with low dielectric constant and good mechanical properties.

### BACKGROUND

Thermoplastic polymers possess excellent mechanical properties, moldability, and chemical resistance. In the electronic industry, high loading of inorganic fillers are incorporated into thermoplastic polymers to achieve composites with low dielectric constant (Dk) for use as housing or supporting materials. However, high loading of inorganic fillers also causes decrease in mechanical properties. Thus, there is still a need to develop composite thermoplastic compositions with low Dk, while maintaining good mechanical properties.

### SUMMARY

Provided herein are polymer compositions with low dielectric constant, which comprise, a) at least one thermoplastic polymer; and b) about 5-95 wt % of core/shell particles, wherein the core/shell particles comprise a core formed of MgTiO₃ and a shell formed of SiO₂, and wherein the weight ratio of MgTiO₃:SiO₂ ranges from about 85:15-15:85; with the total weight of the polymer composition totaling to 100 wt %.

In one embodiment of the polymer composition, the at least one thermoplastic polymer is comprised at a level of about 10-80 wt %, based on the total weight of the polymer composition.

In a further embodiment of the polymer composition, the at least one thermoplastic polymer is comprised at a level of about 20-60 wt %, based on the total weight of the polymer composition.

In a yet further embodiment of the polymer composition, the at least one thermoplastic polymer is comprised at a level of about 25-45 wt %, based on the total weight of the polymer composition.

In a yet further embodiment of the polymer composition, the at least one thermoplastic polymer is selected from the group consisting of polyesters, polyolefins, polyimides, polyamides, polyether imide, polyaryletheretherketone, polyoxymethylenes, and combinations of two or more thereof.

In a yet further embodiment of the polymer composition, the core/shell particles have a weight ratio of MgTiO₃:SiO₂ ranging from about 80:20-20:80.

In a yet further embodiment of the polymer composition, the core/shell particles have a weight ratio of MgTiO₃:SiO₂ ranging from about 75:25-25:75

In a yet further embodiment of the polymer composition, the core/shell particles are comprised at a level of about 25-85 wt % or about 45-75 wt %, based on the total weight of the polymer composition.

In a yet further embodiment of the polymer composition, the core/shell particles are comprised at a level of about 45-75 wt %, based on the total weight of the polymer composition.

Further provided herein are articles formed of the polymer compositions described above.

### DETAILED DESCRIPTION

Disclosed herein are composite polymer compositions with low dielectric constant and good mechanical properties. The composite polymer compositions comprise at least one thermoplastic polymer and dispersed therein core/shell particles, wherein the core/shell particles comprise MgTiO₃ core and SiO₂ shell.

The term “thermoplastic polymer” is used herein referring to polymers that turn to a liquid when heated and freeze to a rigid state when cooled sufficiently. Thermoplastic polymers useful herein include, without limitation, polyesters, polyolefins, polyimides, polyamides, polyether imide, polyaryletheretherketone, polyoxymethylenes, and mixtures thereof. Exemplary polyesters include, without limitation, polyethylene terephthalate (PET), polybutylene terephthalate (PBT), polytrimethylene terephthalate (PTT), polycyclohexylene dimethylene terephthalate (PCT), etc. Exemplary polyolefins include, without limitation, polyethylene, polypropylene, polyolefin elastomer, etc. Suitable polyesters may be obtained commercially from various vendors. For example, suitable PET may be obtained from DuPont de Nemours, Inc. (U.S.A.) (hereafter “DuPont”) under the trade name Rynite®; suitable PBT may be obtained from DuPont under the trade name Crastin® or from Shinkong Synthetics Fibers Corporation (Taiwan) under the trade name Shinite D201; suitable PTT may be obtained from DuPont under the trade name Sorona®; suitable PCT may be obtained from Celanese Corporation (Switzerland), under the trade name Thermx™. Polyolefins used herein also may be obtained commercially from various vendors. For example, suitable polypropylene may be obtained from ExxonMobil under the trade name DOWLEX™ PP4792E1 or from DOW Corporation (USA) under the trade name DOWLEX™; suitable Polyolefin elastomer may be obtained from DOW Corporation (USA), under the trade name ENGAGE™; suitable ethylene-vinyl acetate copolymer (EVA) maybe obtained from DOW Corporation (USA), under the trade name ELVAX™.

In accordance with the present disclosure, about 10-80 wt %, or about 20-60 wt %, or about 25-45 wt % of the thermoplastic polymer may be present in the composition, based on the total weight of the composition.

The core/shell particles used herein are comprised of core that is formed of MgTiO₃ and shell formed of SiO₂. In accordance with the present disclosure, the MgTiO₃ core are completely or partially coated with SiO₂ shell. And the weight ratio of MgTiO₃:SiO₂ ranges from about 85:15-15:85, or from about 80:20-20:80, or from about 75:25-25:75.

The core/shell particles used herein may be prepared by a sol-gel process, such as the process disclosed in PCT Patent Application Publication No. WO201531570 (which is incorporated herein by reference). The sol-gel process includes mixing in a solvent the MgTiO₃ particles, a silica precursor, a hydrolysis, and a surfactant (optional and may be cationic surfactant or amphoteric surfactant) to result in a mixture solution. Such mixing results in chemically reacting the silica precursor to form a layer of SiO₂ coating on the surface of the MgTiO₃ particles. And the core/shell particles may be removed by filtration from the mixture solution.

The solvents used in the sol-gel process are aqueous solution, in which, the MgTiO₃ particles, silica precursors, hydrolysis, and optional surfactants are uniformly dispersed and reacted. Preferably, the solvents used herein are solvent mixtures of water and any one or more of the following: isopropyl alcohol (IPA), methanol, ethanol, methyl ethyl ketone (MEK), methyl isobutyl ketone (MIBK), propylene glycol monomethyl ether (PGME), propylene glycol monomethyl ether acetate (PGMEA), monoethanolamine (MEA), dipropylene glyol diacrylate (DPGDA), and mixtures of two or more thereof. In one embodiment, the solvent is an aqueous solution of water and one or more of the following: isopropyl alcohol (IPA), methanol, ethanol, methyl ethyl ketone (MEK), methyl isobutyl ketone (MIBK), propylene glycol monomethyl ether (PGME), propylene glycol monomethyl ether acetate (PGMEA), monoethanolamine (MEA), dipropylene glyol diacrylate (DPGDA). In one embodiment, the solvent may be a mixture of water and one or more of the following: isopropyl alcohol (IPA), methanol, and ethanol. When the solvent is an aqueous solution of water and IPA, methanol, or ethanol, the amount of solvent may range from about 300 to 5000 weight parts per 100 weight parts of the MgTiO₃ particles and the mass ratio between water and IPA, methanol, and/or ethanol ranges from about 1:3 to about 1:10.

The SiO₂ precursor used in the sol-gel process is the source of the SiO₂ shell.

The SiO₂ precursor may be silicon alkoxide represented by formula (I):

(R¹)ₙSi(OR²)₄₋ₙ

, wherein

R¹ represents hydrocarbons with 1 to 8 identical or different, substituted or unsubstituted carbon atoms, n represents 0, 1, 2, or 3, and R² represents hydrocarbons with 1 to 8 carbon atoms. The silicon alkoxide is reacted with water and the hydrolysis catalyst to create silica, which is the entity that coats the MgTiO₃ particles.

The silicon alkoxide may be tetraalkoxysilane. Or, the tetraalkoxysilane may be tetraethoxysilane, tetramethoxysilane, tetrapropoxysilane, tetrabutoxysilane, tetraamyloxysilane, tetraoctyloxysilane, tetranonyloxysilane, dimethoxy diethoxy silane, dimethoxy diisopropoxy silane, diethoxy diisopropoxy silane, diethoxy dibutoxy silane, diethoxy ditrityloxy silane, or mixtures of two or more thereof.

When the silicon alkoxide is tetraethoxysilane (TEOS, Si(OC₂H₅)₄)), the hydrolysis reaction is:

Si(OC₂H₅)₄₋+2H₂O→SiO₂+4C₂H₅OH

Hydrolysis catalysts promote the hydrolysis reaction of SiO₂ precursors as acidic hydrolysis catalysts or basic hydrolysis catalysts. The methods described herein may use acidic hydrolysis catalysts or basic hydrolysis catalysts. Acidic hydrolysis catalysts are proton (H⁺) donors that promote the hydrolysis reaction through protonation of oxygen atoms, whereas basic hydrolysis catalysts are proton (H⁺) acceptors that promote the reaction by enabling nucleophilic addition through proton transfer from carbon atoms in hydrolysis.

Hydrochloric acid may be preferable as an acidic hydrolysis and ammonium hydroxide may be preferable as a basic hydrolysis catalyst.

Surfactants are optionally included in the sol-gel process. The surfactants used herein may be cationic surfactants with hydrophilic groups that dissociate in aqueous solution into cations or amphoteric surfactants that dissociate in aqueous solution into both anions and cations. The surfactants are used in the process as binders of the MgTiO₃ particles and the silica.

In accordance with the present disclosure, about 5-95 wt %, or about 25-85 wt %, or about 45-75 wt % of the core/shell particles may be present in the composition, based on the total weight of the composition.

The polymer compositions disclosed herein may further comprise other additives, such as colorants, antioxidants, UV stabilizers, UV absorbers, heat stabilizers, lubricants, viscosity modifiers, nucleating agents, plasticizers, mold release agents, scratch and mar modifiers, impact modifiers, emulsifiers, optical brighteners, antistatic agents, acid adsorbents, smell adsorbents, anti-hydrolysis agents, anti-bacterial agents, density modifiers, reinforcing fillers, thermal conductive fillers, electrical conductive fillers, coupling agents, end-capping reagents and combinations of two or more thereof. Based on the total weight of the polymer composition disclosed herein, such additional additive(s) may be present at a level of about 0.005-30 wt % or about 0.01-25 wt %, or about 0.02-20 wt %.

Further disclosed herein are articles formed of the polymeric compositions disclosed herein. Such polymeric compositions can be used in various areas, including, for example, electronic, automobile, and communication industries. Exemplary articles formed of the polymeric composition, include, without limitation, housing, protective, or supporting components in electronic devices.

### EXAMPLES

### Materials

PP—polypropylene obtained from ExxonMobil Corporation under the trade name ExxonMobil™ PP4792E1;
PBT—polybutylene terephthalate obtained from Shinkong Synthetic Fibers Corporation under the trade name Shinite™ D201;
MgTiO₃—MgTiO₃ powder obtained from Shanghai Dian Yang Industry Co. Ltd (China);
SiO₂—SiO₂ powders obtained from Lianyungang Donghai Silica Powder Co., Ltd;
C/S (97/3)—core/shell particles prepared as follows: dispersing TEOS and deionized water in a solvent by stirring; adding MgTiO³ particles into the dispersion; continuing stirring until the dispersion thickened; drying the thickened gel product at 70° C. for 24 hours to obtain the core/shell particles
C/S (90/10)—core/shell particles prepared as above, with a weight ratio between MgTiO₃ and SiO₂ at 90:10;
C/S (70/30)—core/shell particles prepared as above, with a weight ratio between MgTiO₃ and SiO₂ at 70:30;
C/S (50/50)—core/shell particles prepared as above, with a weight ratio between MgTiO₃ and SiO₂ at 50:50.

In each of comparative examples CE1-CE6 and examples E1-E4, a polymer composition (all components listed in Table 1) was prepared by compounding in an extruder. The barrel temperatures were set at about 220° C. and screw speed at about 300 rpm. After exiting the extruder, the blended compositions were cooled and cut into resin pellets, which was followed by drying overnight.

The dried resin pellets obtained in each example were injection molded into 60+60+1 mm test plaques, and the dielectric constant (Dk) value was measured and tabulated in Table 1.

Further, for each sample, the tensile stress and tensile strain at break were measured in accordance with ISO 527-2:2012; the flexure stress was measured in accordance with ISO 178; and the UN charpy impact was measured in accordance with ISO 179-1. Results are tabulated in Table 1.

As demonstrated herein, when core/shell particles with a weight ratio of MgTiO₃:SiO₂ between 85:15-15:85 was incorporated in thermoplastic polymers (e.g., E1-E4), the dielectric constant (Dk) value was decreased to 3 compared to those compositions using MgTiO₃ particles or core/shell particles with a weight ratio of MgTiO₃:SiO₂ less than 15:85. Moreover, although the dielectric constant (Dk) value of 3 was achieved when SiO₂ powder was used, the mechanical properties of the composition was poor compared to the examples.

TABLE 1

| | | | | | | | | | |
|---|---|---|---|---|---|---|---|---|---|
| CE1 | E1 | CE2 | CE3 | E2 | E3 | E4 | CE4 | CE5 | CE6 |

Compositions

| | | | | | | | | | | |
|---|---|---|---|---|---|---|---|---|---|---|
| PP (wt %) | — | — | 30 | 30 | 30 | 30 | 30 | 30 | 30 | 30 |
| PBT (wt %) | 30 | 30 | — | — | — | — | — | — | — | — |
| MgTiO₃ (wt %) | 70 | — | — | — | — | — | — | 70 | — | 49 |
| SiO₂ (wt %) | — | — | — | — | — | — | — | — | 70 | 21 |
| C/S (97/3) (wt %) | — | — | 70 | — | — | — | — | — | — | — |
| C/S (90/10) (wt %) | — | — | — | 70 | — | — | — | — | — | — |
| C/S (70/30) (wt %) | — | — | — | — | 70 | — | — | — | — | — |
| C/S (50/50) (wt %) | — | — | — | — | — | 70 | — | — | — | — |
| C/S (30/70) (wt %) | — | 70 | — | — | — | — | 70 | — | — | — |

Properties

| | | | | | | | | | | |
|---|---|---|---|---|---|---|---|---|---|---|
| Dk (at 2.45 GHz) | 6 | 3 | 4 | 4 | 3 | 3 | 3 | 5 | 3 | 4 |
| Tensile Stress | N/D* | N/D* | N/D* | N/D* | N/D* | N/D* | 29 | 20 | 25 | 22 |
| (MPa) | | | | | | | | | | |
| Tensile strain at | N/D* | N/D* | N/D* | N/D* | N/D* | N/D* | 1.7 | 1.3 | 0.8 | 0.6 |
| break (%) | | | | | | | | | | |
| Flexure stress | ND* | N/D* | N/D* | N/D* | N/D* | N/D* | 50 | 39 | 45 | 34 |
| (MPa) | | | | | | | | | | |
| UN-charpy impact | ND* | N/D* | N/D* | N/D* | N/D* | N/D* | 11.29 | 9.67 | 8.97 | 7.49 |
| (KJ/m²) | | | | | | | | | | |

*N/D: not determined.

1. A polymer composition with low dielectric constant, comprises,
a) at least one thermoplastic polymer; and
b) about 5-95 wt % of core/shell particles, wherein the core/shell particles comprise a core formed of MgTiO3 and a shell formed of SiO2, and wherein the weight ratio of MgTiO3:SiO2 ranges from about 85:15-15:85;
with the total weight of the polymer composition totaling to 100 wt %.

2. The polymer composition of claim 1, wherein, the at least one thermoplastic polymer is comprised at a level of about 10-80 wt %, based on the total weight of the polymer composition.

3. The polymer composition of claim 2, wherein, the at least one thermoplastic polymer is comprised at a level of about 20-60 wt %, based on the total weight of the polymer composition.

4. The polymer composition of claim 3, wherein, the at least one thermoplastic polymer is comprised at a level of about 25-45 wt %, based on the total weight of the polymer composition.

5. The polymer composition of claim 1, wherein, the at least one thermoplastic polymer is selected from the group consisting of polyesters, polyolefins, polyim ides, polyamides, polyether imide, polyaryletheretherketone, polyoxymethylenes, and combinations of two or more thereof.

6. The polymer composition of claim 1, wherein the ore/shell particles have a weight ratio of MgTiO3:SiO2 ranging from about 80:20-20:80.

7. The polymer composition of claim 6, wherein the ore/shell particles have a weight ratio of MgTiO3:SiO2 ranging from about 75:25-25:75

8. The polymer composition of claim 1, wherein the core/shell particles are comprised at a level of about 25-85 wt % or about 45-75 wt %, based on the total weight of the polymer composition.

9. The polymer composition of claim 8, wherein the core/shell particles are comprised at a level of about 45-75 wt %, based on the total weight of the polymer composition.

10. An article formed of the polymer composition of claim 1 recited in any one of claims 1-9.
